(19) United States
(12) Patent Application Publication
(10) Pub. No.: US 2019/0018698 A1
(43) Pub. Date: Jan. 17, 2019

(54) OPTIMIZING VIRTUAL MACHINE PLACEMENT FOR MULTI-DESTINATION TRAFFIC

(71) Applicant: Nicira, Inc., Palo Alto, CA (US)

(72) Inventor: Dexiang WANG, San Jose, CA (US)

(21) Appl. No.: 15/651,925

(22) Filed: Jul. 17, 2017

(51) Int. Cl. G06F 9/455

(52) U.S. Cl. CPC G06F 9/45558; G06F 2009/4557; G06F 2009/45595

(57) ABSTRACT

A technique for placing virtual computing instances in hosts in a data center to improve capacity and scalability in the network connecting the hosts in the data center. The network is viewed in regard to the physical placement of the servers and resource slots the servers have for supporting virtual computing instances and in regard to the communication traffic between virtual computing instances supported by the servers. A management system collects the resource slots into slot clusters based on their physical location and the virtual computing instances into virtual computing instance clusters based on communication traffic between pairs of virtual computing instances. The management system then maps the virtual computing instance clusters to the slot clusters to determine their physical placement in the network. The improved physical placement allows the management system to add additional VMs to the network or the existing VMs to have improved performance because high-traffic VMs are placed physically close to each other.

### BACKGROUND

Data centers employ a large number of servers or hosts each of which can support a large number of virtual machines or virtual computing instances. Management systems running the data centers can assign application tasks that require the virtual machines to communicate with each other over the links and switches in the data center network. During processing of an application task, a measurable pattern of communication traffic develops among the virtual machines involved with a task. Some of the virtual machines involved with the task may have high communication traffic among them, but they may be situated physically far from each other. This creates a problem, as the high, non-local traffic is routed over a greater number of links and switches of the network in the data center than if the traffic were local. The non-local traffic consumes a greater amount of network capacity than if the high-traffic virtual machines were physically close. Non-local, high-traffic virtual machines create an inefficient, wasteful use of the network resources (i.e., the links and switches of the data center).

### SUMMARY

Embodiments provide a technique for placing virtual computing instances in a network of hosts, such that the total amount of network capacity consumed by the virtual computing instances is reduced.

In one embodiment, a method of placing the virtual computing instances among hosts includes determining communication traffic between each different pair of the virtual computing instances, determining slots of available resources in the hosts, where each slot is sufficient to support one of the virtual computing instances, assigning each slot to one of the plurality of slot clusters of different sizes based on a physical location of each slot, assigning each virtual computing instance to one virtual computing instance cluster of a plurality of virtual computing instance clusters of different sizes based on the determined communication traffic between each pair of virtual computing instances, and deploying the virtual computing instances in a first virtual computing instance cluster, which is one of the virtual computing instance clusters, to the slots in a first slot cluster, which is one of the slot clusters having the same size as the first virtual computing instance cluster.

In another embodiment, a data center includes a plurality of hosts, each having a number of available slots for supporting virtual computing instances, a plurality of switches, a plurality of links interconnecting the hosts in the plurality of hosts and the switches in the plurality of switches, and a resource scheduling server configured to (i) determine communication traffic between each different pair of the virtual computing instances, (ii) determine slots of available resources in the hosts, where each slot is sufficient to support one of the virtual computing instances, (iii) assign each slot to one of a plurality of slot clusters of different sizes based on a physical location of each slot, (iv) assign each virtual computing instance to one virtual computing instance cluster of a plurality of virtual computing instance clusters of different sizes based on the determined communication traffic between each pair of virtual computing instances, and (v) deploy the virtual computing instances in a first virtual computing instance cluster, which is one of the virtual computing instance clusters, to the slots in a first slot cluster, which is one of the slot clusters having the same size as the first virtual computing instance cluster.

Further embodiments include, without limitation, a non-transitory computer-readable storage medium that includes instructions for a processor to carry out the above method.

### BRIEF DESCRIPTION OF THE DRAWINGS

FIG. 1A depicts a data center and management system for the data center in which an embodiment can be practiced.

FIG. 1B depicts an exemplary data center in detail, in an embodiment.

FIG. 1C depicts a block diagram of a host computer system that is representative of a virtualized computer architecture, in an embodiment.

FIG. 2A depicts a representation of the physical topology of the data center of FIG. 1B, in an embodiment.

FIG. 2B depicts another representation of the physical topology of FIG. 2A, in an embodiment.

FIGS. 3A and 3B provide a representation of example communication traffic among virtual machines in the data center, in an embodiment.

FIG. 4 depicts the top-level steps for efficiently placing virtual machines into available slots, in an embodiment.

FIG. 5A depicts steps for placing the available slots into a given number of slot clusters, in an embodiment.

FIG. 5B depicts the evolution of a set of slot clusters in accordance with the steps depicted in FIG. 5A, in an embodiment.

FIG. 6A is a top level flowchart depicting the steps involved in placing virtual machines into virtual machine clusters, in an embodiment.

FIG. 6B depicts steps for finding all min-cut sets, in an embodiment.

FIG. 6C depicts steps for forming a virtual machine cluster based on a sorted list of min-cut sets, in an embodiment.

FIG. 6D depicts steps of finding a set of connected components using the sorted minimum cut-set list, in an embodiment.

FIG. 6E depicts steps for attempting to make a vCluster using a FindSubset algorithm.

FIGS. 6F, 6G, 6H and 61 depict example graphs to illustrate the steps of FIGS. 6A, 6B, 6C, 6D, 6E.

FIG. 7A depicts the mapping step 406 of FIG. 4, in an embodiment.

FIG. 7B depicts the result of the mapping step in FIG. 7A, in an embodiment.

### DETAILED DESCRIPTION

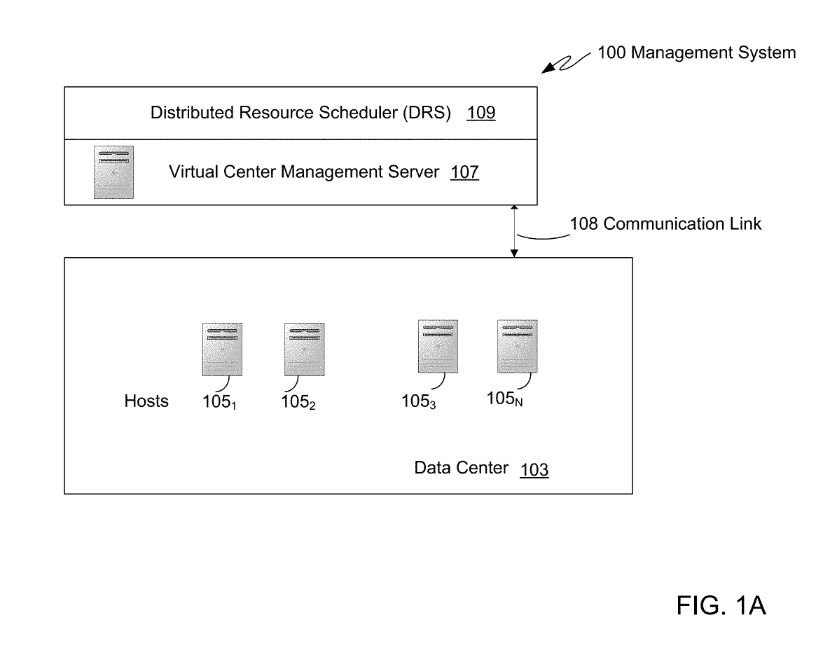

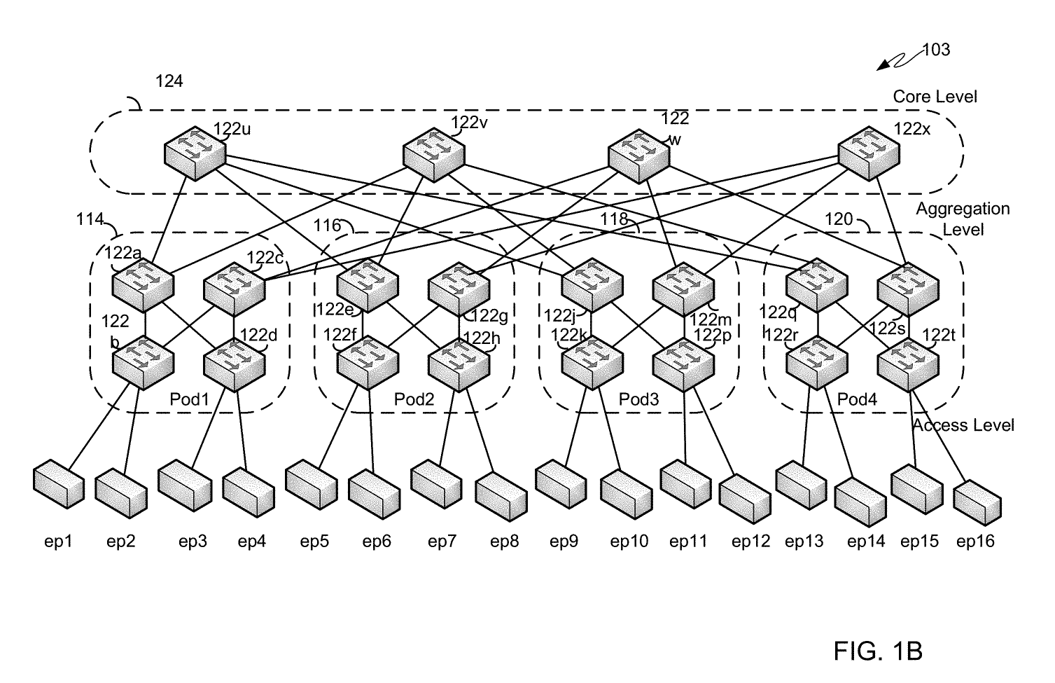

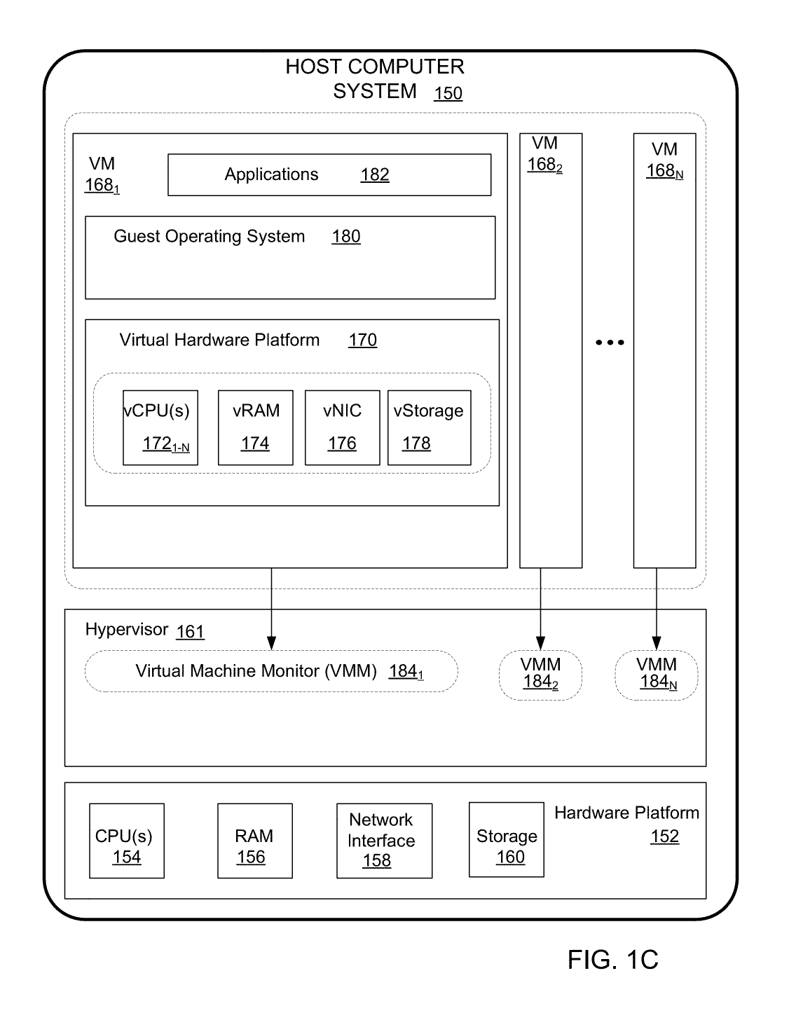

FIG. 1A depicts a data center 103 and a management system 100 for a data center 103 in which an embodiment can be practiced. Management system 100 communicates with data center 103 through a communication link 108. Data center 103 includes a large number of hosts 105₁-105_{N}, each of which is capable of supporting a large number of virtual machines. A detailed representation of a host 150 of hosts 105₁-105_{N} is illustrated in FIG. 1C. Management system 100 in data center 103 runs on a Virtual Center Management Server 107 and includes at least a Distributed Resource Scheduler (DRS) 109. DRS 109 enables a system administrator to set resource assignment policies that reflect business needs of data center 103. DRS 109 carries out calculations to automatically handle physical resource assignments, including placement or replacement of virtual machines among hosts 105₁-105_{N} in data center 103.

FIG. 1B depicts data center 103 in more detail. Data center 103 includes many endpoints ep1-ep16 at each of which host 150 (FIG. 1C) may be present, where host 150 supports a number of virtual machines 168₁-168_{N}. Each endpoint ep1-ep16 also represents a number of slots, from one to a plurality of slots, such that each slot is a possible physical location for a virtual machine on host 150. Endpoints ep1-ep16 are connected via switches 122a-122x at the access level, aggregation level and core level. In the figure, a pod of switches 114, 116, 118, 120 connects the endpoints ep1-ep16 to a core set 124 of switches 122u, 112v, 122w, 122x. This allows each endpoint to connect to any other endpoint.

FIG. 1C depicts a block diagram of a computer system that may serve as host 150, such as hosts 105₁-105_{N} depicted in FIG. 1A. FIG. 1C is representative of a virtualized computer architecture. As is illustrated, host 150 supports multiple virtual machines (VMs) 168₁-168_{N} that run on and share a common hardware platform 152. Hardware platform 152 includes conventional computer hardware components, such as one or more central processing units (CPUs) 154, random access memory (RAM) 156, one or more network interfaces 158, and a persistent storage 160.

A virtualization software layer, hereinafter referred to as a hypervisor 161, is installed on top of hardware platform 152. Hypervisor 161 makes possible the concurrent instantiation and execution of one or more VMs 168₁-168_{N}. The interaction of a VM 168 with hypervisor 161 is facilitated by the virtual machine monitors (VMMs) 184₁-184_{N}. Each VMM 184₁-184_{N} is assigned to and monitors a corresponding VM 168₁-168_{N}. In one embodiment, hypervisor 161 may be a VMkernel™ which is implemented as a commercial product in VMware's vSphere® virtualization product, available from VMware™ Inc. of Palo Alto, Calif. In an alternative embodiment, hypervisor 161 runs on top of a host operating system, which itself runs on hardware platform 152. In such an embodiment, hypervisor 161 operates above an abstraction level provided by the host operating system.

After instantiation, each VM 168₁-168_{N} encapsulates a hardware platform 170 that is executed under the control of hypervisor 161. Virtual hardware platform 170 of VM 168₁, for example, includes but is not limited to such virtual devices as one or more virtual CPUs (vCPUs) 172₁-172_{N}, a virtual random access memory (vRAM) 174, a virtual network interface adapter (vNIC) 176, and virtual storage (vStorage) 178. Virtual hardware platform 170 supports the installation of a guest operating system (guest OS) 180, which is capable of executing applications 182. Examples of guest OS 180 include any of the well-known operating systems, such as the Microsoft Windows™ operating system, the Linux™ operating system, and the like.

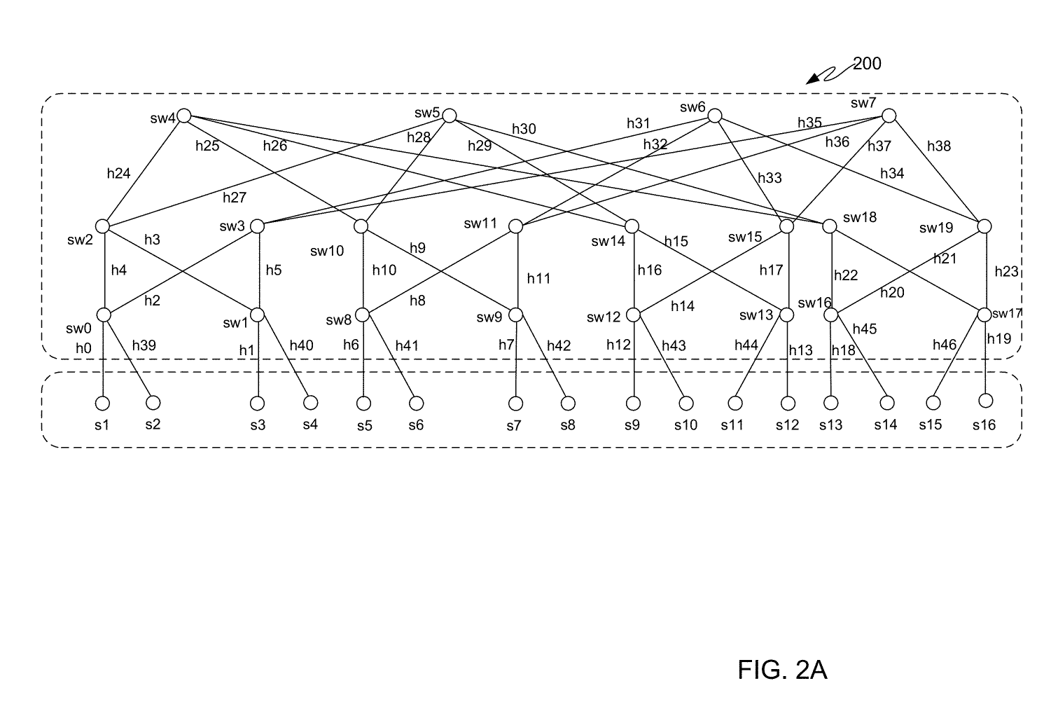

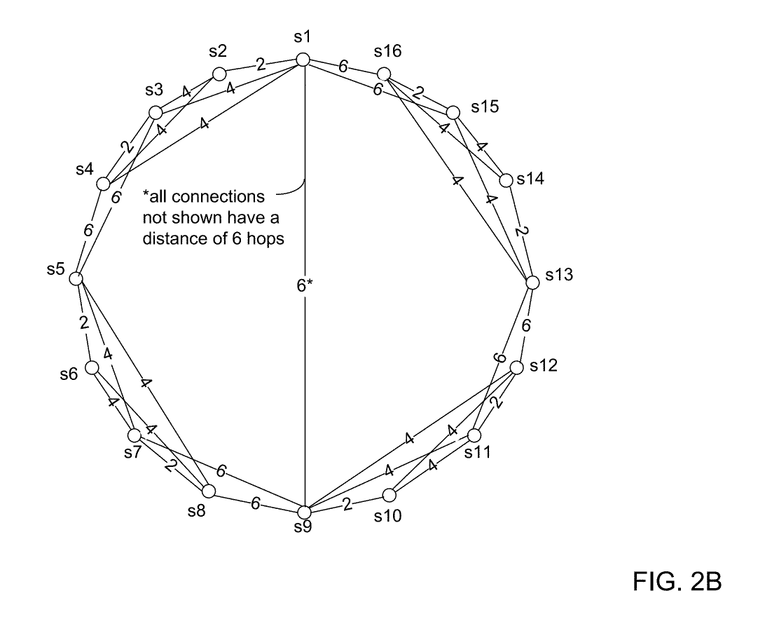

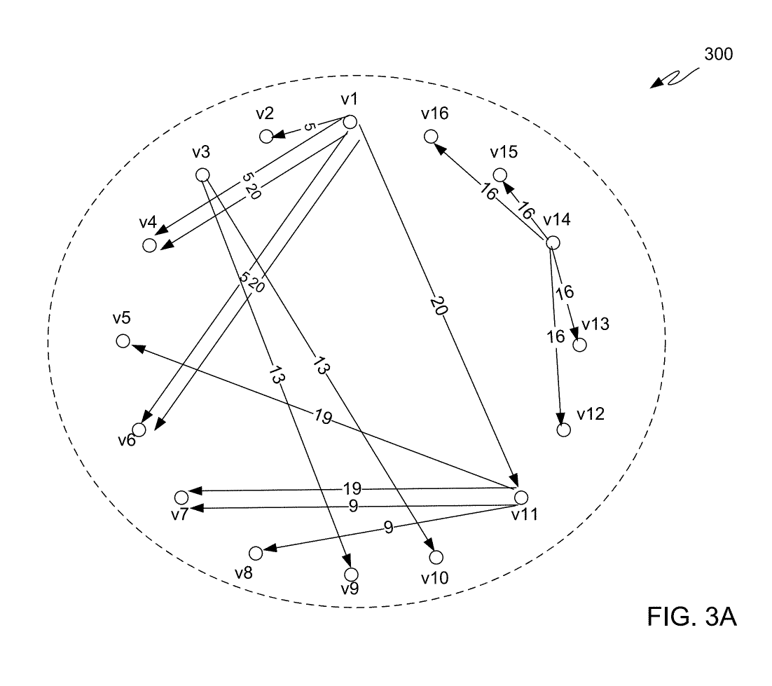

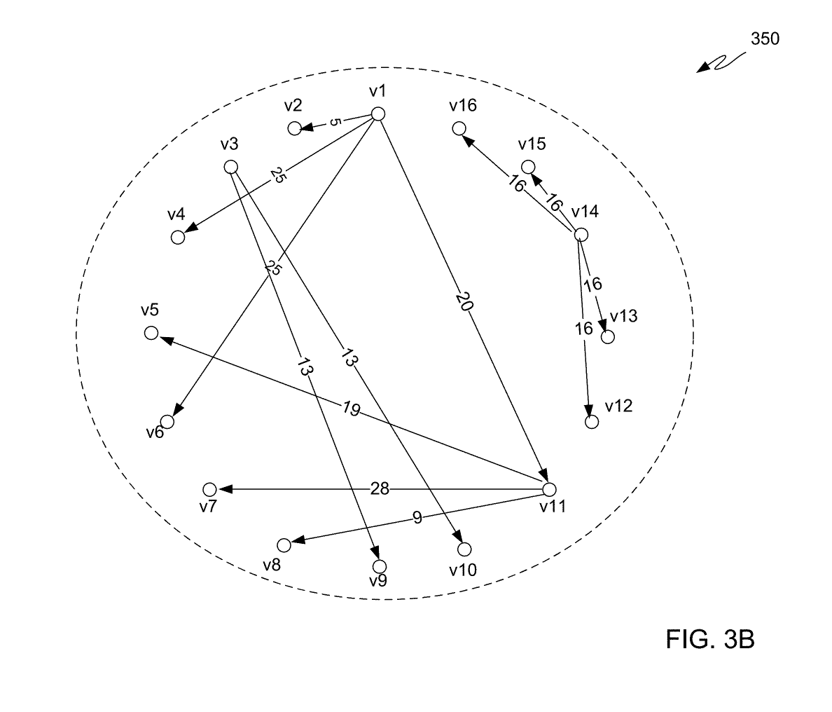

To develop a placement technique that improves the capacity of the network depicted in FIG. 1B, it is desirable to consider the network of FIG. 1B from two viewpoints, one being the physical topology (FIG. 2A) and the other being the communication traffic (FIG. 3A).

FIG. 2A depicts an example physical topology graph 200 for the physical topology of data center 103 of FIG. 1B. The particular connections (links) and nodes of the physical topology graph 200 are shown as examples only, for purposes of explanation. Physical topology graph 200 of data center 103 may have a variety of physical topologies, with a variety of nodes, quantity of nodes, connections, and quantity of connections, depending on the particular network within data center 103. Physical topology graph 200 includes slots s1-s16, where each slot of slots s1-s16 is an available collection of resources sufficient to support or contain one of the virtual machines v1-v16 (FIG. 3) on host 150 and where resources include CPU, volatile memory, and non-volatile storage. In this example, each host supports only one slot of the slots s1-s16.

FIG. 2A, depicts slots each of which represents a possible physical location for a virtual machine and captures the information regarding the physical locations of each slot of a set of slots s1-s16. Slots s1-s16 are connected by switches, denoted as sw0-sw19, which provide communication paths between slots s1-s16. For convenience in describing embodiments herein, each link h0-h46 between a slot or a switch has a distance measurement called a “hop.” The greater number of hops, the greater the physical distance between two points in the physical topology.

FIG. 2A thus depicts the topological distance (number of hops), and thus generally the physical distance between slots s1-s16. Topological distance between slots s1-s16 is summarized by the graph in FIG. 2B. For example, the distance between slot s1 and slot s5 is six hops, because the shortest path from s1 to s5 is six hops. One path from s1 to s5 is h0, h4, h27, h28, h10, and h6. The distance between slots s1 and s3 is four hops, with one path being h0, h4, h3, h1, and another path being h0, h2, h5, h1. The distance between s3 and s4 is two hops, the path being h1, h40. In the graph in FIG. 2B for the example network of FIG. 2A, the minimum topological distance is two, and the maximum topological distance is six, with only some of the paths having six hops shown. It is noted that the topological distance is one way of approximating physical distance between slots. Other ways of approximating physical distance include actual units of distance measure, such as meters or kilometers. When using a weight unit other than hops, the weights labeled on the edges of FIG. 2B change, but the process as described herein remains substantially the same.

FIG. 3A provides a communication traffic graph 300 of example communication traffic among virtual machines v1-v16 in data center 103 without regard to the physical location of virtual machines v1-v16, in an embodiment. DRS 109 can collect or derive this communication traffic periodically using a utility such as IPFIX, available from VMware™, in one embodiment. Each directed edge represents communication traffic from a first virtual machine to a second virtual machine connected by that edge. Thus, in the example, the communication traffic rate between v1 and v2 over directed edge v1→v2 is 5 units and the traffic between v11 and v8 over directed edge v11→v8 is 9 units, where the units are proportional to the actual traffic rate.

Given the graphs in FIGS. 2B and 3A, a technique to improve the use of the network is to place in the virtual machines of FIG. 3 into the slots of FIG. 2B so as to reduce cost of traffic in the network represented by graphs 200 and 300. Let i be an index representing a multi-destination traffic flow Rᵢ within a network. This multi-destination flow has a source virtual machine and a set of destination virtual machines, with traffic moving from the source virtual machine to all of the destination virtual machines at a communication traffic rate of R. Each destination virtual machine may be separated from the source virtual machine by one or more links. Let Cᵢ represent the total number of links between the source VM and each of the destination VMs. For example, if a multi-destination traffic flow has two destination VMs, then Cᵢ is the total number of links between source and the two destination VMs. The communication cost for one of the multi-destination flows is thus the product of the traffic rate Rᵢ and the total number of links Cᵢ between the source VM and the set of destination VMs. Total communication cost for a network with such traffic can be calculated by summing the communication cost of each multi-destination traffic flow within that network and can be represented by the expression Σ_{i=1 . . . M} RᵢCᵢ, where M is the total number of different multi-destination traffic flows within the network.

This cost can be reduced by finding some mapping of virtual machines to the available slots. However, the number of calculations needed for finding the mapping that improves the cost function is very large because multi-destination traffic Rᵢ needs to be determined for each of M different multi-destination traffic flows. In fact, such a problem is considered NP-hard, which means it cannot be solved in polynomial time and achieve an optimal result.

Thus, it is desirable to find an efficient and quick way of determining placement of virtual machines into available slots in the network that improves the cost function for the given traffic flows. Any placement that does improve the cost function will hold until the traffic pattern changes significantly, at which point a new placement based on a new traffic pattern is performed. In one embodiment, DRS 109 can determine that a significant change in traffic has occurred according to the following. Periodically (e.g., once a day), DRS 109 performs a new placement according to the techniques presented herein based on the current communication traffic and computes the current communication cost based on that placement and the current traffic. DRS 109 can then compare the current communication cost to the communication cost based on the new placement. If DRS 109 determines that the difference exceeds a certain threshold (i.e., such as a percentage threshold), then DRS 109 can recommend or deploy the new placement using vMotion®.

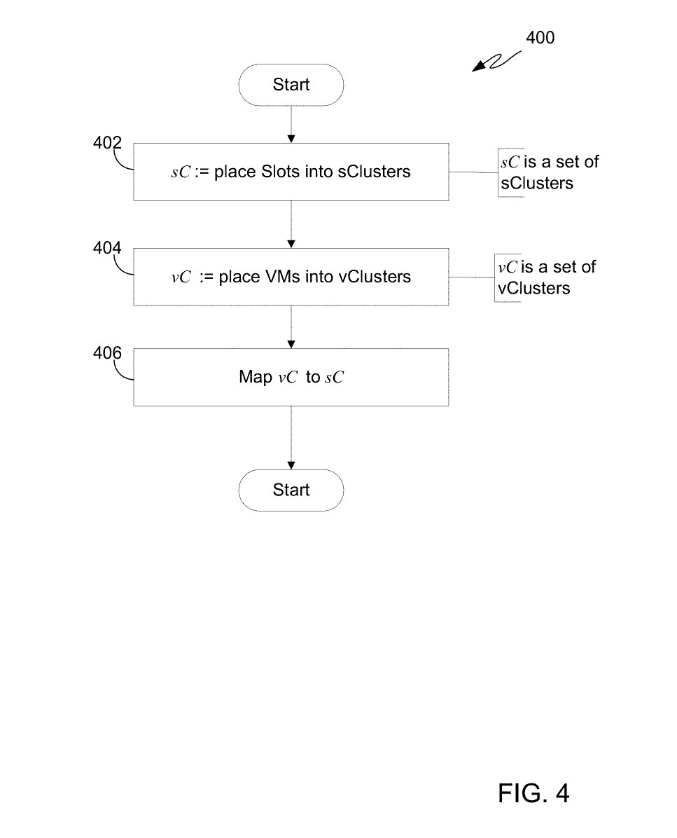

FIG. 4 depicts the top-level steps 400 performed by DRS 109 of FIG. 1A for placing virtual machines in the available slots in an efficient manner based on the physical proximity of the slots and the communication traffic rates between virtual machines. The process of placing virtual machines into slots requires that the number of virtual machines equal the number of available slots. In case fewer virtual machines are present than slots, dummy virtual machines can be introduced, such that the dummy virtual machines do not generate or receive multi-destination traffic. Adding dummy virtual machines does not affect optimality of the solution.

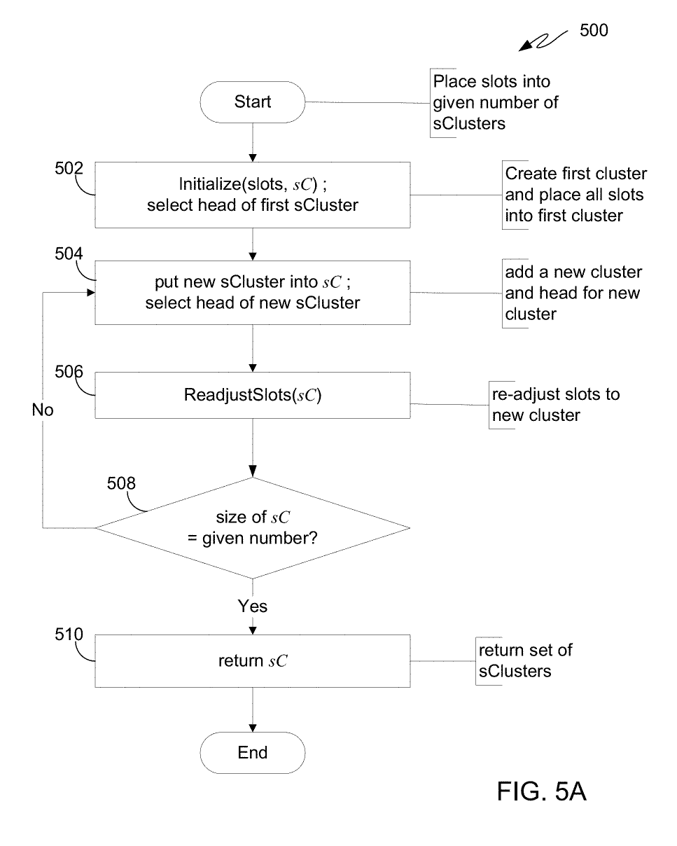

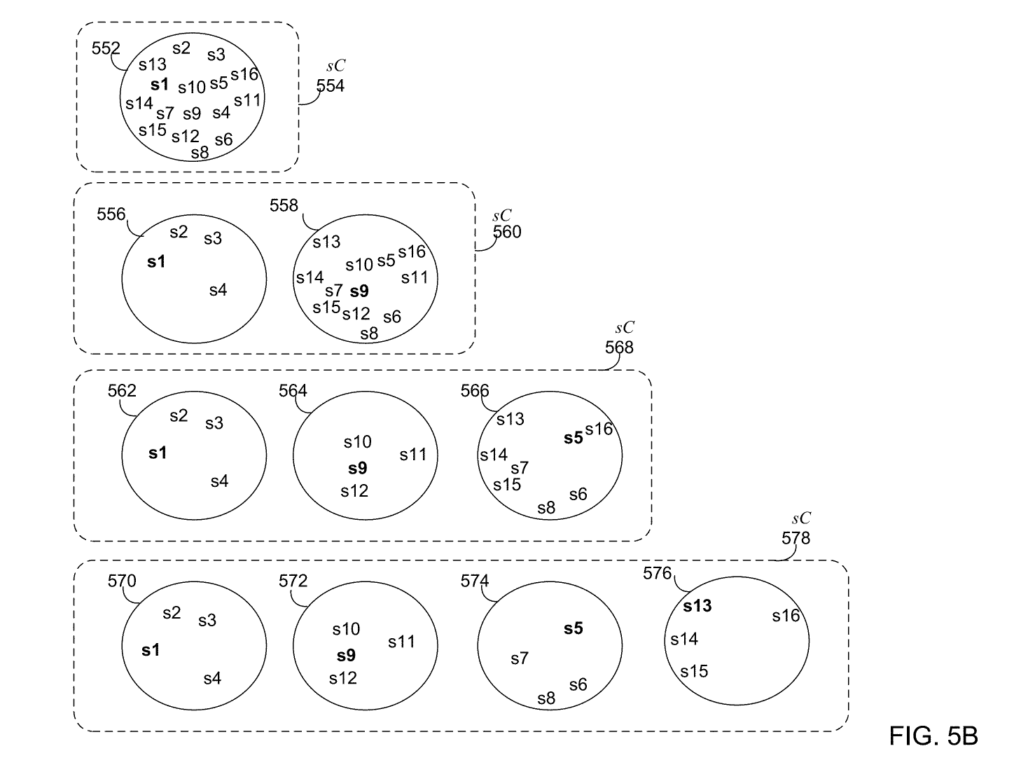

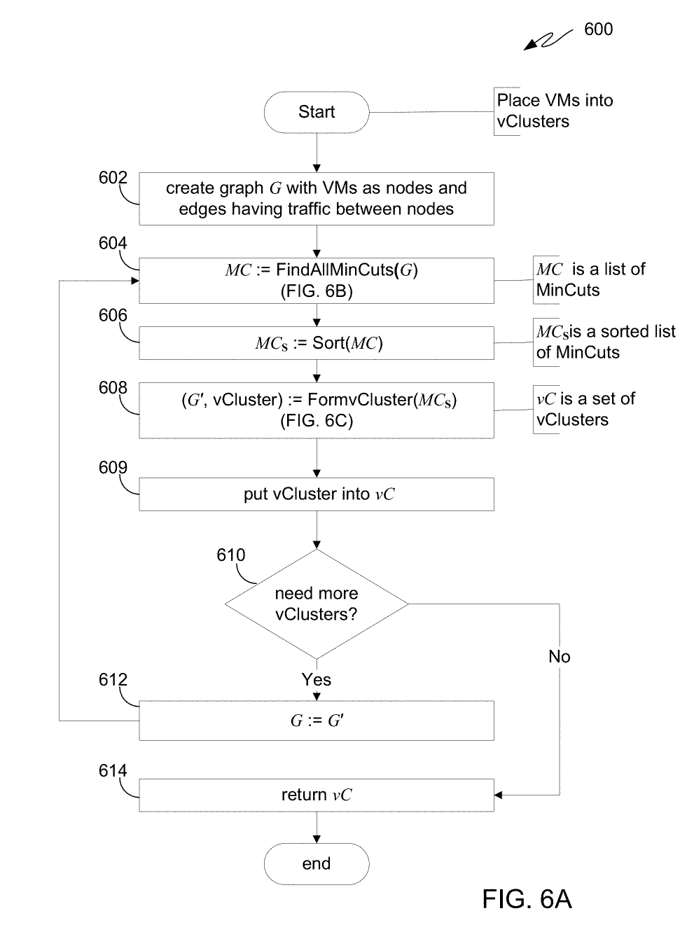

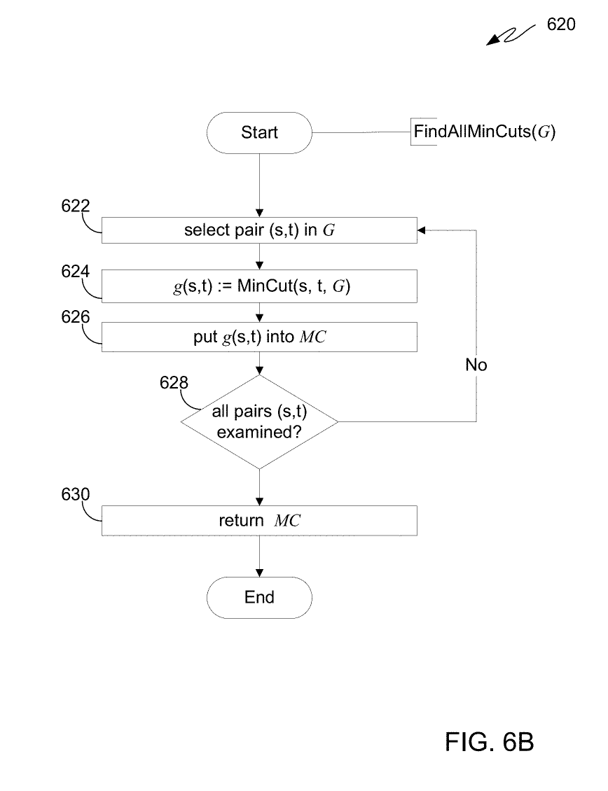

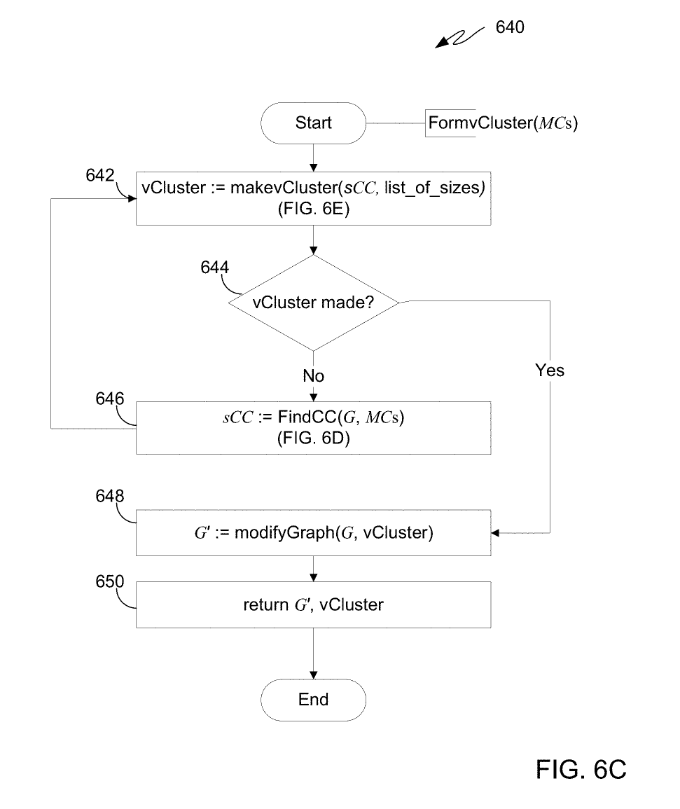

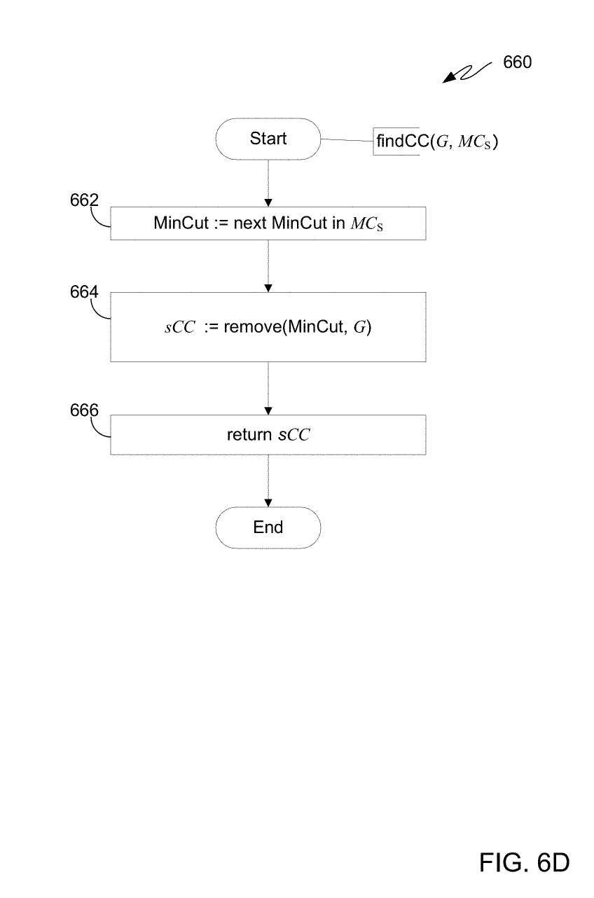

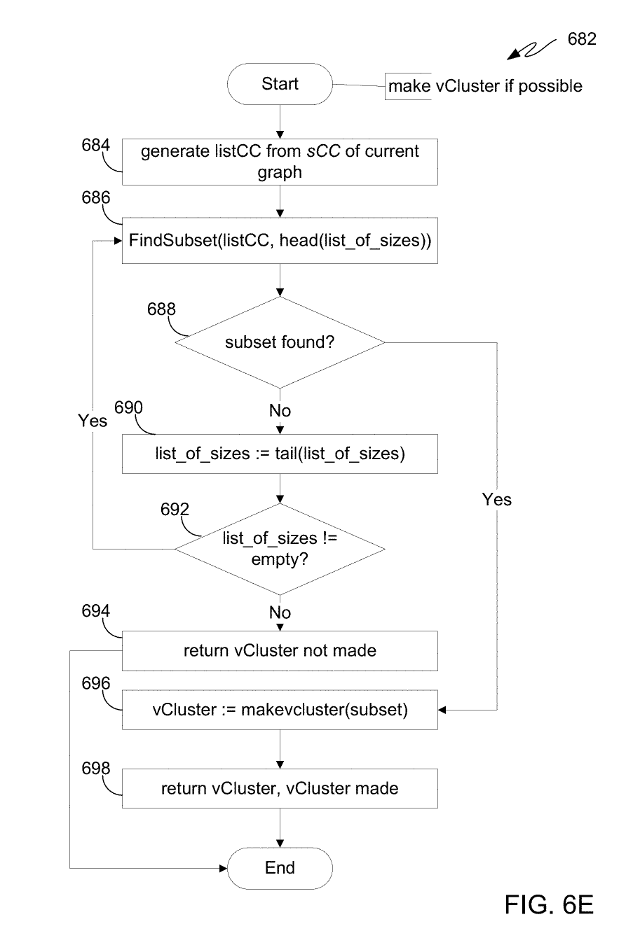

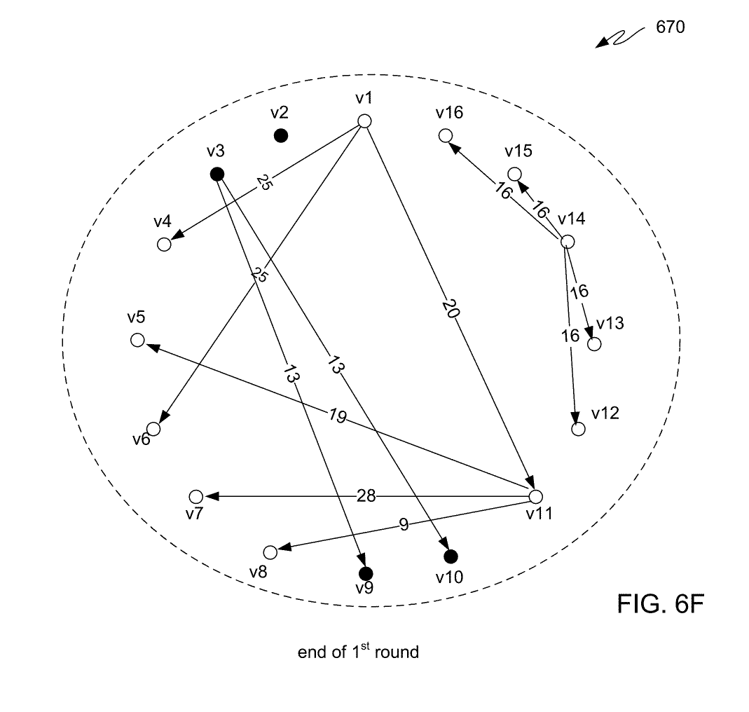

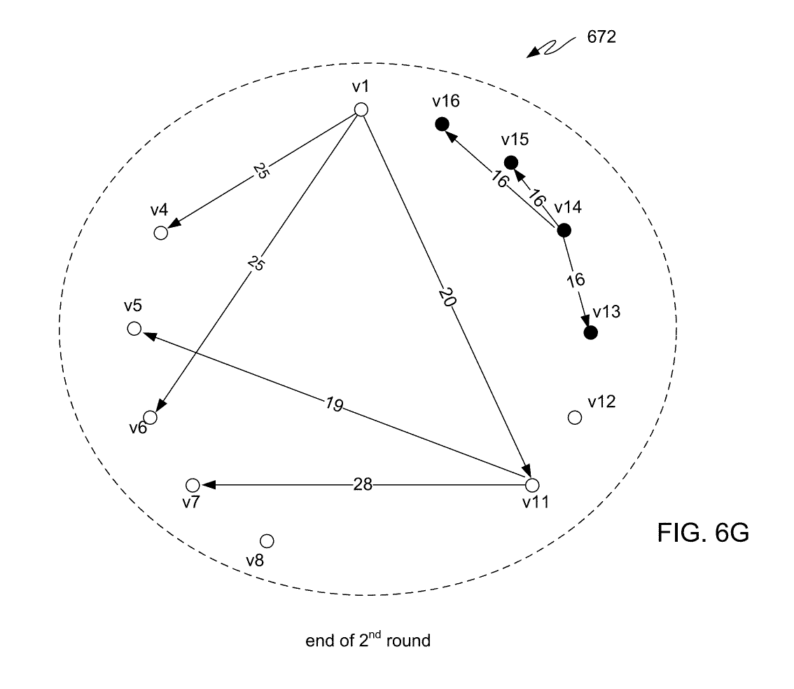

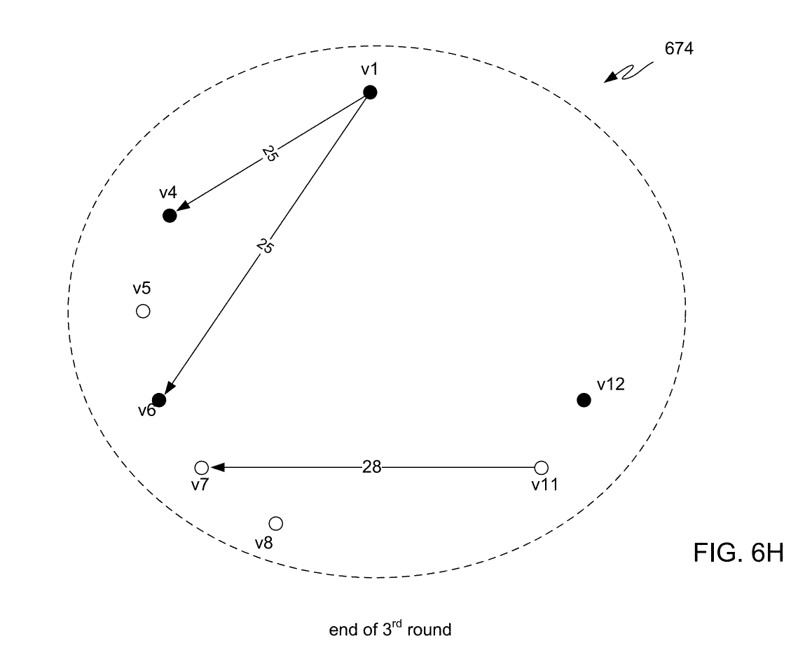

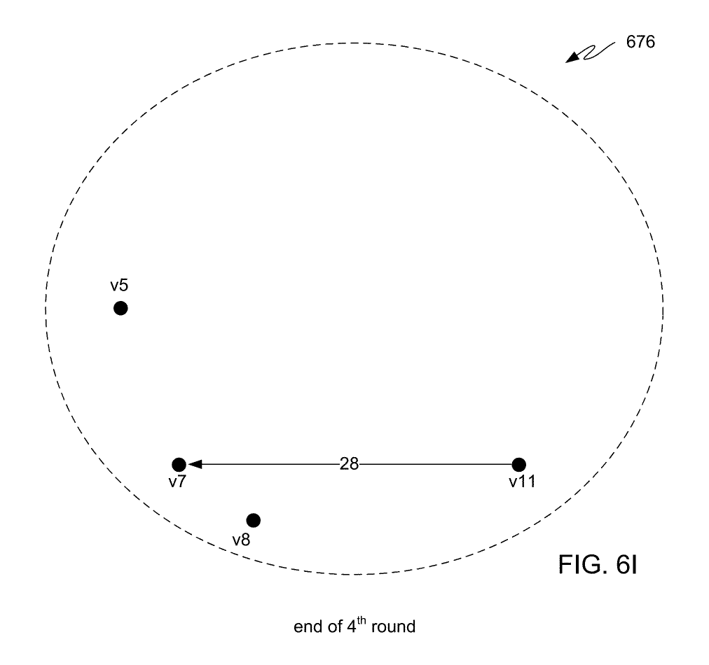

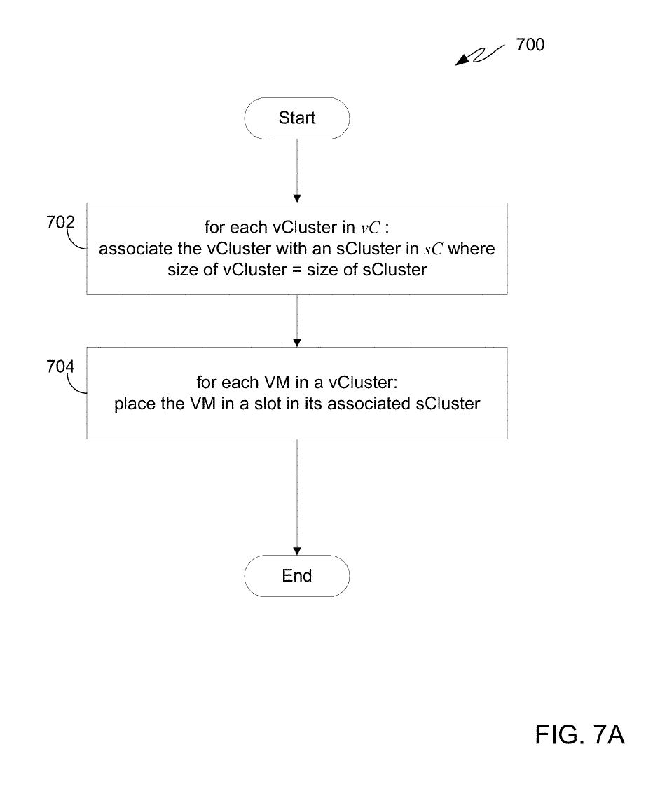

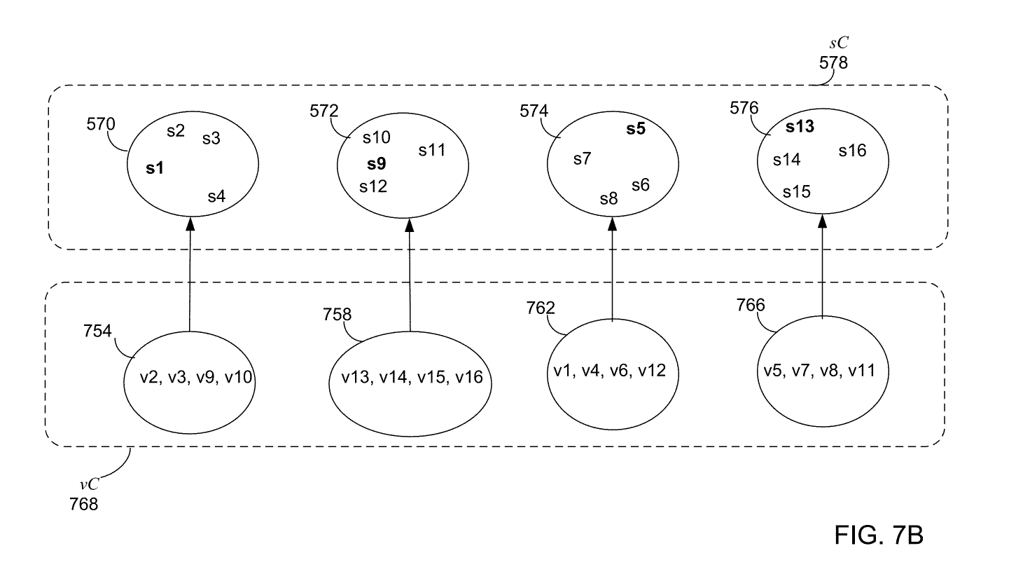

Steps 400 of FIG. 4 break down the problem of efficiently placing virtual machines into slots in three steps. The first step (402) partitions slots into slot clusters such that the topological distance between slots within the same cluster is reduced. The second step (404) partitions virtual machines into virtual machine clusters such that each virtual machine has higher pair-wise traffic within the virtual machine cluster compared to its pair-wise traffic across virtual machine clusters. The third step (406) maps virtual machine clusters to slot clusters. Step 402 is further expanded upon in FIG. 5A and illustrated in FIG. 5B. Step 404 is further expanded upon by FIGS. 6A-6D. Step 406 is further expanded upon by FIG. 7A.

More particularly, in step 402, DRS 109 places available slots s1-s16 into a given number of slot clusters 570-576 (FIG. 5B), hereinafter termed sClusters, based on topology of slots s1-s16 in the network. This means that slots s1-s16 that are physically close to each other, as determined by edge weights in the graph of FIG. 2B, are grouped into the same sCluster. Slots not within the same cluster are relatively farther from each other relative to distance to slots within their own cluster. The result is set (sC) of sClusters. In sC 578 (FIG. 5B) for example, each slot is an element of a slot cluster 570-576 (FIG. 5B), and each slot cluster is an element of the set sC 578 of clusters.

In step 404, DRS 109 places available virtual machines v1-v16 (FIG. 3) into virtual machine clusters 754-766 (FIG. 7B), hereinafter termed vClusters, based on the rate of communication between the virtual machines v1-v16. The result is a set, vC, of vClusters with each VM placed into one of the vClusters of the set vC. However, in step 404, instead of considering communication traffic from each source node to a set of destination nodes, DRS 109 modifies the multi-destination traffic graph of FIG. 3A to become a single-destination traffic graph 350 depicted in FIG. 3B by aggregating all of the multi-destination traffic between each pair of nodes to a single amount. For example, multi-destination traffic between nodes v1 and v4 of 5 units and 20 units is aggregated to become pair-wise traffic of 25 units between nodes v1 and v4. Similarly, multi-destination traffic between nodes v1 and v6 is aggregated to become 25 units and that between v11 and v7 is aggregated to become 28 units, as shown in FIG. 3B. Thus, after converting multi-destination traffic graph 300 to single-destination (i.e., pair-wise) traffic graph 350, the goal is to find a virtual machine placement such that the pair-wise traffic between that virtual machine and another virtual machine in the same vCluster is higher than between that virtual machine and a virtual machine in a different vCluster. Converting the multi-destination traffic graph to a pair-wise traffic graph simplifies the VM placement problem. In step 406, DRS 109 maps the set vC to the set sC.

The above steps 402, 404, and 406 of FIG. 4 thus achieve a placement for the VMs on hosts based on the communication traffic between VMs and their proximity in the host network in a manner that reduces the cost function and does so in polynomial time. Each step is described in more detail below.

FIG. 5A depicts steps 500 performed by DRS 109 for placing the available slots into a given number of sClusters 570-576, in an embodiment, expanding upon step 402 of FIG. 4. In step 502, DRS 109 performs an initialization step in which a single sCluster is created and all of the available slots s1-s16 are placed into the single sCluster. In addition, DRS 109 selects one of the slots as a head for the single sCluster. In step 504, DRS 109 creates a new sCluster and adds it to the set, (i.e., sC) of sClusters. DRS 109 does this by first making a new empty sCluster and then selecting a slot, other than the head, from the initial sCluster that has the largest distance to the head of the first sCluster and making the selected slot the head of the new empty sCluster. If multiple slots have an equally large distance from the head of the initial cluster, then an arbitrary slot out of these multiple slots is chosen as the head of the new sCluster. In step 506, DRS 109 examines the slots in the initial sCluster, except the head, and moves those slots satisfying a proximity threshold to the head of the new cluster from the initial sCluster to the new sCluster. One example of a threshold is a slot having a distance closer or equal to the head of the new sCluster, which is the example threshold used in FIG. 5B. Another example threshold is a slot having a distance closer to the head of the new sCluster than to the head of the initial cluster.

In step 508, if the number of sClusters is not equal to the given number, then DRS 109 repeats steps 504 and 506 until the given number of sClusters is present in set sC. In each iteration, the distance of previously placed slots to the head of their cluster is compared to their distance to the head of the new cluster, and if previously placed slots meet a proximity threshold to the new head, then those slots are relocated to the new slot cluster. In step 510, the set sC of sClusters is returned. In one embodiment, the given number of sClusters is a fixed parameter for flow of FIG. 5A. In another embodiment, the given number is a configurable parameter set by a system administrator based on a value recommendation from DRS 109.

FIG. 5B depicts the evolution of the set of slot clusters s1-s16 in accordance with the steps depicted in FIG. 5A, in an embodiment when making, for example, four slot clusters. In FIG. 5B, DRS 109 places all of the available slots s1-s16 into an initial sCluster 552. In sCluster 552, DRS 109 declares slot s1 (shown as bolded text) to be the head of sCluster 552. Thus, set sC 554 has only sCluster 552. In FIG. 5B, as per the steps of FIG. 5A, DRS 109 then forms a new sCluster 558 and designates a new head, s9, for sCluster 558, where the new head has an equal or larger distance to s1 than any other slot in the head of initial sCluster 552. If multiple slots have the same larger distance, then any one of them can be selected as the head. Next, DRS 109 moves slots in initial sCluster 552 to new sCluster 558 if they have a smaller or equal distance to the head of new sCluster 558 than the head of initial sCluster 552. Set sC 560 now has two sClusters 556 and 558. As it is desired to have four clusters in the example, DRS 109 repeats steps 504, 506 and 508 with a new head. Slot s5 is declared the head of the new sCluster 566. Again, DRS 109 reassigns slots in the first two sClusters 562, 564 if they are closer to the new head of third sCluster 566 or the same distance to the new head of third sCluster 66, when compared to the heads of the first two sClusters 562, 564. Set sC 568 now has three sClusters 562, 564, 566. DRS 109 repeats the process once more, adding a new sCluster 576 and declaring that s13 is the head of sCluster 576. DRS 109 reassigns slots in the first three clusters if they are closer or equidistant to the new head of sCluster 576, when compared to the heads of the previously formed clusters. The set sC 578 now has four sClusters 570, 572, 574, 576, each of which has four slots, the four clusters being sufficient to hold sixteen virtual machines v1-v16.

Next, according to the step 404 in FIG. 4, DRS 109 places VMs into vClusters based on the communication traffic among them.

FIG. 6A is a top-level flowchart 600 depicting the steps DRS 109 performs to place VMs v1-v16 into vClusters. In step 602, DRS 109 constructs a graph G, such as the graph of FIG. 3B, where each node in the graph represents a virtual machine and each directed edge between nodes has a weight that represents an amount of traffic directed between the nodes it connects. In one embodiment, the graph is represented by a two-dimensional array whose rows and columns are the nodes and whose entries are the weights between nodes, with zero representing no connection between nodes.

In step 604, DRS 109 finds in G a list of all min-cuts, denoted MC. For example, a min-cut in graph 350 of FIG. 3B is edge v11→v8, because it separates node v8 from v1 and has a weight of 9, which is lowest weight edge separating v8 from v1. Details of step 604 are depicted in FIG. 6B, which is explained below.

In step 606, the DRS 109 sorts the list of all possible min-cuts MC in graph G, resulting in a sorted list MC_{S}. DRS 109 sorts the list MC, according to the sum of the edge weights within each min-cut set, from lowest to highest. Any min-cuts that have equal edge weight sums can be listed in any order relative to each other.

In step 608, DRS 109 forms a vCluster of a size equal to one of the unmatched slot clusters (sClusters) using the sorted list of min-cuts, MC_{S}, and returns the new vCluster and a modified graph G′, which is graph G without nodes and edges of the new vCluster. A formed vCluster has a size equal to the quantity of virtual machines within that vCluster and matches an sCluster, whose size is the quantity of slots within the sCluster. Details of step 608 are depicted in FIG. 6C.

In step 609, DRS 109 puts the new vCluster into a list vC. As the steps of FIG. 6C include the steps of FIGS. 6D and 6E, the steps of FIGS. 6C, 6D and 6E are performed before DRS 109 can place a vCluster into set vC.

In step 610 of FIG. 6A, DRS 109 tests to determine whether more vClusters are needed. This is determined by comparing the current number of formed vClusters to the number of unmatched sClusters, and if the numbers are not equal, then more vClusters need to be formed. If more vClusters need to be formed, DRS 109 updates in step 612 graph G based on graph G′ returned in step 608 and repeats steps 604-612 until all vClusters are made. Updating the graph G means the removal of the nodes and edges of the new vCluster from graph G to create a new graph G′.

In step 612, DRS 109 then makes the new graph G′ the current graph G so that the process can repeat.

In step 614, DRS 109 returns the set vC of vClusters, the set vC having a size equal to the set sC and each vCluster in the set vC having a size that matches one of the sClusters in the set sC. The following paragraphs provide more details for these steps and the process is illustrated with an example in FIGS. 6E-6H.

As mentioned, FIG. 6B depicts the steps 620 performed by DRS 109 for finding all min-cuts in graph G, in an embodiment. As mentioned above, min-cuts are edges whose sum of weights is the smallest for the purpose of separating a given source node from a given destination node. In step 622 of FIG. 6B, DRS 109 selects from current graph G a source and destination pair (s, t), and in step 624 conducts a search in graph G to find the min-cut set having edges whose sum of edge weights is the smallest and that completely separates the source from a destination. In one embodiment, DRS 109 uses a Ford-Fulkerson method. In another embodiment, DRS 109 uses a Gomory-Hu algorithm. In step 626, DRS 109 puts the resulting min-cut set g(s, t) (i.e., a set of edges) into list MC. In step 628, DRS 109 tests to determine if all possible pairs have been considered. If not, DRS 109 repeats steps 622, 624, 626. In step 630, list MC of all possible min-cuts of graph G is returned.

FIG. 6C depicts the steps 640 performed by DRS 109 to form a vCluster based on the sorted list MC_{S} of min-cut sets, which occurred in step 606. In step 642, DRS 109 uses a set sCC for the current graph, where sCC contains the sets of connected nodes and isolated nodes in the current graph, and a list_of_sizes contains the sizes of all of the unmatched sClusters, to attempt to make a vCluster. For example, the set sCC of connected nodes in graph 3B is {v1, v2, v4, v6, v11, v5, v7, v8}, {v3, v9, v10}, {v12, v13, v14, v15, v16}}. DRS 109 performs this function by running an aggregation algorithm described in FIG. 6E and using sCC and the variable list_of_sizes. If no cluster can be made, as determined in step 644, DRS 109 then removes the next min-cut from the sorted list MC_{S} in step 646 to form a new set sCC on which FindSubset is run to determine if a new vCluster can be formed. If a vCluster can be made as determined in step 644, then the graph is modified to create graph G′ in step 648 by removing the nodes and edges of the newly formed vCluster from the current graph, removing a matched sCluster from consideration, and updating the list_of_sizes variable to contain sizes of only the remaining unmatched sClusters. In step 640, the modified graph G′ and the newly formed vCluster are returned.

FIG. 6D depicts the steps 660 performed by DRS 109 for finding a set of connected components sCC using the sorted min-cut list MC_{S}, in an embodiment. In step 662, DRS 109 removes the first min-cut (i.e., its edges) in MC_{S} from the current graph G and in step 664 forms the set sCC containing the resulting connected components. For example, if for the graph in FIG. 3B min-cut v1→v2 is removed, set sCC contains {v2, v4, v6, v11, v5, v7, v8}, {v3, v9, v10}, {v12, v13, v14, v15, v16}, {v2}}. In step 666, DRS 109 returns the set sCC to step 646 in FIG. 6C to see if a new vCluster can be formed from the elements in set sCC.

FIG. 6E depicts steps 682 for attempting to make a vCluster using a FindSubset algorithm. In step 684, a listCC is generated for the current set sCC, where listCC is a list of integer sizes corresponding to each item in the set sCC. For example, for the graph of FIG. 3B, listCC=[8, 5, 3]. In step 686, the FindSubset algorithm is run using listCC and the first item in list_of_sizes (i.e., head(list_of_sizes)) to find a subset in listCC that has a size matching one in list_of_sizes. In one embodiment, FindSubset a is subset-sum algorithm implemented recursively. In another embodiment, FindSubset is implemented with bottom-up or top-down dynamic programming so that it can complete in polynomial time. If running FindSubset(listCC, head(list_of_sizes)) finds a subset matching the first item (i.e., the head) in the list, as determined in step 688, then DRS 109 forms a vCluster from the connected components corresponding to the subset and returns the vCluster and a vCluster-made flag in step 698. If a subset is not found, as determined in step 688, then list_of_sizes is updated in step 690 (i.e., list_of_sizes:=tail(list_of_sizes) and if the list is not empty as determined in step 692, then next item in the list_of_sizes is used to attempt to find a subset in step 686. If DRS 109 discovers that no subset can be made that matches any item in the list_of_sizes, as determined in step 692, then a vCluster-not-made flag is returned to cause a new attempt using a new set sCC of connected components. Eventually, after removing sufficient min-cuts according to the steps in FIG. 6C, a new vCluster will be formed.

FIGS. 6F, 6G, 6H and 61 depict graphs to illustrate the steps of FIGS. 6A, 6B, 6C, 6D and 6E using example graph 350 of FIG. 3B. In the discussion below, a round is completed when a vCluster is found.

In a first round, according to the steps in FIG. 6A, DRS 109 finds the all of the min-cut sets of the pair-wise traffic graph G 350, depicted in FIG. 3B, places them into a list and sorts the list. This comprises steps 602 to 606 of FIG. 6A. Table 1 sets out the list of sorted min-cut sets for each pair of nodes that has a cut set based on the example graph of FIG. 3B. It is noted that in the following example, all min-cut sets are singletons, (i.e., they contain only one edge). However, with other graphs and/or sClusters, a min-cut set g(s, t) can include many edges.

TABLE 1
MCₛ

| Source and destination nodes s, t | Min-CutSet g(s, t) | Edge Weight |
|---|---|---|
| v1, v2 | v1→v2 | 5 |
| v1, v8 | v11→v8 | 9 |
| v11, v8 | v11→v8 | 9 |
| v3, v9 | v3→v9 | 13 |
| v3, v10 | v3→v10 | 13 |
| v14, v12 | v14→v12 | 16 |
| v14, v13 | v14→v13 | 16 |
| v14, v15 | v14→v15 | 16 |
| v14, v16 | v14→v16 | 16 |
| v1-v5 | v11→v5 | 19 |
| v11, v5 | v11→v5 | 19 |
| v1, v7 | v1→v11 | 20 |
| v1, v11 | v1→v11 | 20 |
| v1, v4 | v1→v4 | 25 |
| v1, v6 | v1→v6 | 25 |
| v11, v7 | v11-v7 | 28 |

In Table 1, each pair of nodes is listed along with a set of edges that comprise a min-cut set, and the sum of the weights of that set. For example, the min-cut set between nodes v1, v8 is the set {v11→v8}, containing one edge.

First, DRS 109 runs the FindSubset algorithm to determine if the current graph 350 in FIG. 3B can be used to form a vCluster. If not, then DRS 109 removes the first min-cut {v1→v2} from the graph 350 in FIG. 3B. The graph 670 now has the following set sCC equal to {{v1, v4, v6, v11, v5, v7,v8}, {v3,v9,v10}, {v12,v13,v14,v15,v16},{v2}}. In accordance with FIG. 6C, step 644 tries to make a vCluster from the elements of sCC, by running FindSubset(sCC, list_of_sizes), using the corresponding listCC=[7, 5, 3, 1] and list_of_sizes=[4, 4, 4, 4]. Clearly, the CCs of sizes 3 and 1 can be aggregated to form the vCluster {v2, v3, v9, v10}, the nodes of which are shown as filled in graph 670. Accordingly, the nodes and edges of {v2, v3, v9, v10} are removed from a graph 670 for the beginning of the next round. Removing the nodes and edges of the nodes constituting the vCluster guarantees that those nodes and edges are not considered in a later round. A matching sCluster 570 is also removed from further consideration for matching to connected components, and the list_of_sizes variable (e.g., [4, 4, 4, 4]) is updated to remove one of the sizes to be matched from the list (i.e., the list is now [4, 4, 4]). This completes the first round because a vCluster was formed.

The process in FIG. 6A is repeated on graph 670 modified to remove {v2, v3, v9, v10}. In this second round, DRS 109 finds the all of the min-cut sets of a new graph, which are then placed into a list and sorted.

Table 2 sets out the list of sorted min-cut sets for the second round.

TABLE 2
MCₛ

| Source and destination nodes s, t | Min-CutSet g(s, t) | Edge Weight |
|---|---|---|
| v1, v8 | v11→v8 | 9 |
| v11, v8 | v11→v8 | 9 |
| v14, v12 | v14→v12 | 16 |
| v14, v13 | v14→v13 | 16 |
| v14, v15 | v14→v15 | 16 |
| v14, v16 | v14→v16 | 16 |
| v1-v5 | v11→v5 | 19 |
| v11, v5 | v11→v5 | 19 |
| v1, v7 | v1→v11 | 20 |
| v1, v11 | v1→v11 | 20 |
| v1, v4 | v1→v4 | 25 |
| v1, v6 | v1→v6 | 25 |
| v11, v7 | v11-v7 | 28 |

As the current graph 670 in FIG. 6F (without {v2, v3, v9, v10}) has no connected components that can be used to form another vCluster, DRS 109 now removes min-cut v11→v8 from the graph. This leaves a set of components whose listCC=[6, 5, 1]. In accordance with FIG. 6C, step 644 tries to make a vCluster from the elements of sCC, by running FindSubset, where the corresponding listCC=[6, 5, 1] and list_of_sizes=[4, 4, 4]. However, no vCluster can be formed in this case. Therefore, the next min-cut v14→v12 is removed from the graph. This leaves sCC equal to {{v1, v4, v6, v11, v5, v7}, {v13, v14, v15, v16}, {v8}, {v12}} and corresponding listCC=[6, 4, 1, 1]. DRS 109 runs FindSubset, where listCC=[6, 4, 1, 1] and list_of_sizes=[4, 4, 4] and this time a vCluster {v13, v14, v15, v16} can be formed. DRS 109 then removes nodes and edges for {v13, v14, v15, v16} which has size 4 from the graph and updates the list_of_sizes variable to contain [4, 4]. Thus, the second round ends because a new vCluster was formed and the third round begins.

TABLE 3
MCₛ

| Source and destination nodes s, t | Min-CutSet g(s, t) | Edge Weight |
|---|---|---|
| v1-v5 | v11→v5 | 19 |
| v11, v5 | v11→v5 | 19 |
| v1, v7 | v1→v11 | 20 |
| v1, v11 | v1→v11 | 20 |
| v1, v4 | v1→v4 | 25 |
| v1, v6 | v1→v6 | 25 |
| v11, v7 | v11-v7 | 28 |

In the third round, DRS 109 runs the FindSubset algorithm on graph 672 of FIG. 6G modified to remove {v13, v14, v15, v16} and determines that no additional vCluster can be formed with the current set sCC. Thus, DRS 109 removes v11→v5. Set sCC now equals {{v1, v4, v6, v11, v7}, {v5}, {v8}, {v12} } and corresponding listCC=[5, 1, 1, 1]. DRS 109 runs the FindSubset algorithm and discovers that no vCluster can be formed from the current sCC. Thus, DRS 109 removes the next min-cut v1→v11. Now set sCC={{v1, v4, v6}, {v11, v7}, {v12}, {v5}, {v8} } with corresponding listCC=[3, 2, 1, 1, 1]. DRS 109 runs FindSubset, where listCC=[3, 2, 1, 1, 1] and list_of_sizes=[4, 4] and discovers that an aggregation is possible and DRS 109 forms a vCluster={v1, v4, v6, v12}. DRS 109 then removes nodes and edges for {v1, v4, v6, v12} from the graph and updates the list_of_sizes variable to contain [4]. It should be noted that several other vClusters could be formed with listCC=[3, 2, 1, 1, 1]. For example, vCluster={v11, v7, v12, v5} could have been formed.

TABLE 4
MCₛ

| Source and destination nodes s, t | Min-CutSet g(s, t) | Edge Weight |
|---|---|---|
| v1, v4 | v1→v4 | 25 |
| v1, v6 | v1→v6 | 25 |
| v11, v7 | v11-v7 | 28 |

In the fourth round, DRS 109 runs the FindSubset algorithm on graph 674 of FIG. 6H modified to remove the set {v1, v4, v6, v12} and discovers the set sCC of connected components is {v11,v7},{v5},{v8}} with corresponding listCC=[2, 1, 1]. Therefore, a vCluster {{v5, v7, v8, v11} } can be formed by aggregating as shown in graph 676 of FIG. 6I. DRS 109 then removes nodes and edges for {v5, v7, v8, v11} from the graph 688 and updates the list_of_sizes variable to remove the last item. As the list_of_sizes is now empty, all needed vClusters have been formed.

With the sets sC and vC now determined, the mapping step 406 of FIG. 4 is performed by DRS 109. The details of step 406 are in FIG. 7A.

FIG. 7A depicts the mapping steps 700. In step 702, DRS 109 associates each vCluster in vC with an sCluster in sC having the same size as the vCluster. In step 704, DRS 109 places each VM of a vCluster into one of the slots of the sCluster with which it is associated. The placement of the particular VM within a vCluster into a particular slot in an sCluster to which the vCluster is already mapped is arbitrary.

FIG. 7B depicts the result of the mapping steps 700 in FIG. 7A. In the example illustrated, a vCluster 754 containing virtual machines v2, v3, v9 and v10 is mapped to sCluster 570 containing slots s1, s2, s3 and s4. The vCluster 758 containing nodes v13, v14, v15 and v16 is mapped to sCluster 572 containing slots s9, s10, s11 and s12. The vCluster 762 containing nodes v1, v4, v6 and v12 is mapped to sCluster 574 containing slots s5, s6, s7 and s8. Finally, the vCluster 766 containing nodes v5, v7, v8 and v11 is mapped to sCluster 576 containing slots s13, s14, s15 and s16.

In FIG. 7B, the total internal traffic flow is 26 units within vCluster 754, 48 units within vCluster 758, 50 units, within vCluster 762 and 28 units within vCluster 766. Moreover, the total traffic within each cluster is generally larger than the traffic between clusters. For example, the total traffic between vCluster 754 and all other vClusters is 0 units. The only traffic between vClusters is that between vCluster 762 and vCluster 766, which is 20 units.

The result is that virtual machines having the pair-wise highest traffic are placed next to each other physically, thus reducing the amount of traffic between clusters that are not as close. Therefore, the cost function Σ_{i=1 . . . M} RᵢCᵢ relating to a deployment of virtual machines according to the techniques described herein can be greatly reduced. It is observed that the gain provided by these techniques depends on the span of the multi-destination traffic, where span is the set of communicating nodes involved in the multi-destination flow. As smaller spans can be more easily accommodated by smaller sClusters which feature improved locality, smaller spans thus lead to greater gains compared to the case in which the virtual machines are randomly placed in data center 103. In addition, gains are also improved when multicast replication mode is carried truly by multicast in the physical topology, rather than pure unicast forwarding.

Certain embodiments as described above involve a hardware abstraction layer on top of a host computer. The hardware abstraction layer allows multiple contexts or virtual computing instances to share the hardware resource. In one embodiment, these virtual computing instances are isolated from each other, each having at least a user application running therein. The hardware abstraction layer thus provides benefits of resource isolation and allocation among the virtual computing instances. In the foregoing embodiments, virtual machines are used as an example for the virtual computing instances and hypervisors as an example for the hardware abstraction layer. As described above, each virtual machine includes a guest operating system in which at least one application runs. It should be noted that these embodiments may also apply to other examples of virtual computing instances, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method of placing virtual computing instances on hosts, comprising:
determining communication traffic between each different pair of the virtual computing instances;
determining slots of available resources in the hosts, each slot being sufficient to support one of the virtual computing instances;
assigning each slot to one of a plurality of slot clusters of different sizes based on a physical location of each slot;
assigning each virtual computing instance to one virtual computing instance cluster of a plurality of virtual computing instance clusters of different sizes based on the determined communication traffic between each pair of virtual computing instances; and
deploying the virtual computing instances in a first virtual computing instance cluster, which is one of the virtual computing instance clusters, to the slots in a first slot cluster, which is one of the slot clusters having the same size as the first virtual computing instance cluster.

2. The method of claim 1, wherein the number of the plurality of virtual computing instance clusters is equal to the number of the plurality of slot clusters and the size of each virtual computing instance cluster matches the size of at least one of the slot clusters.

3. The method of claim 1, further comprising determining the slots in the first slot cluster as a placement destination for the virtual computing instances in the first virtual computing instance cluster based on physical locations of the hosts whose resources support the slots in the first slot cluster.

4. The method of claim 1, wherein the hosts are connected by a plurality of switches and determining the physical locations of the hosts is based on connections of the hosts to one or more switches in the plurality of switches.

5. The method of claim 1, wherein determining communication traffic between each pair of virtual computing instances includes measuring the communication traffic while virtual computing instances run an application.

6. The method of claim 5, wherein the determined communication traffic between each pair of virtual computing instances is a maximum flow between each pair of virtual computing instances.

7. The method of claim 1, wherein assigning each virtual computing instance to one virtual computing instance cluster in the plurality of virtual computing instance clusters includes assigning each virtual computing instance so that the determined communication traffic between the assigned virtual computing instance and another virtual computing instance in the same cluster is greater than the determined communication traffic between the assigned virtual computing instance and another virtual computing instance in a different virtual computing instance cluster.

8. A non-transitory computer readable medium containing instructions that configure a processor to carry out a method for placing virtual computing instances on hosts, the method comprising:
determining communication traffic between each different pair of the virtual computing instances;
determining slots of available resources in the hosts, each slot being sufficient to support one of the virtual computing instances;
assigning each slot to one of a plurality of slot clusters of different sizes based on a physical location of each slot;
assigning each virtual computing instance to one virtual computing instance cluster of a plurality of virtual computing instance clusters of different sizes based on the determined communication traffic between each pair of virtual computing instances; and
deploying the virtual computing instances in a first virtual computing instance cluster, which is one of the virtual computing instance clusters, to the slots in a first slot cluster, which is one of the slot clusters having the same size as the first virtual computing instance cluster.

9. The non-transitory computer readable medium of claim 8, wherein the number of the plurality of virtual computing instance clusters is equal to the number of the plurality of slot clusters and the size of each virtual computing instance cluster matches the size of at least one of the slot clusters.

10. The non-transitory computer readable medium of claim 8,
wherein the method further includes determining the slots in the first slot cluster as a placement destination for the virtual computing instances in the first virtual computing instance cluster based on physical locations of the hosts whose resources support the slots in the first slot cluster.

11. The non-transitory computer readable medium of claim 8, wherein the hosts are connected by a plurality of switches and determining the physical locations of the hosts is based on connections of the hosts to one or more switches in the plurality of switches.

12. The non-transitory computer readable medium of claim 8, wherein determining communication traffic between each pair of virtual computing instances includes measuring the communication traffic while virtual computing instances run an application.

13. The non-transitory computer readable medium of claim 12, wherein the determined communication traffic between each pair of virtual computing instances is a maximum flow between each pair of virtual computing instances.

14. The non-transitory computer readable medium of claim 8, wherein assigning each virtual computing instance to one virtual computing instance cluster in the plurality of virtual computing instance clusters includes assigning each virtual computing instance so that the determined communication traffic between the assigned virtual computing instance and another virtual computing instance in the same cluster is greater than the determined communication traffic between the assigned virtual computing instance and another virtual computing instance in a different virtual computing instance cluster.

15. A data center comprising:
a plurality of hosts, each host having a number of available slots for supporting virtual computing instances;
a plurality of switches; and
a plurality of links interconnecting the hosts in the plurality of hosts and the switches; and
a resource scheduling server configured to:
determine communication traffic between each different pair of the virtual computing instances;
determine slots of available resources in the hosts, each slot being sufficient to support one of the virtual computing instances;
assign each slot to one of a plurality of slot clusters of different sizes based on a physical location of each slot;
assign each virtual computing instance to one virtual computing instance cluster of a plurality of virtual computing instance clusters of different sizes based on the determined communication traffic between each pair of virtual computing instances; and
deploy the virtual computing instances in a first virtual computing instance cluster, which is one of the virtual computing instance clusters, to the slots in a first slot cluster, which is one of the slot clusters having the same size as the first virtual computing instance cluster.

16. The data center of claim 15, wherein the number of the plurality of virtual computing instance clusters is equal to the number of the plurality of slot clusters and the size of each virtual computing instance cluster matches the size of at least one of the slot clusters.

17. The data center of claim 15, wherein each of the slots in a slot cluster has a smaller number of links interconnecting the slot with another slot in the slot cluster compared to a number of links interconnecting the slot with another slot in a different cluster.

18. The data center of claim 15, wherein each of the virtual computing instances in any one of the virtual computing instance clusters has a greater amount of communication traffic with another virtual computing instance in the same virtual computing instance cluster compared the amount of communication traffic with another virtual computing instance in a different virtual computing instance cluster.

19. The data center of claim 15, wherein the communication traffic between each different pair of virtual computing instances is obtained from measurements of communication traffic between the pair of virtual computing instances while the virtual computing instances are executing an application.

20. The data center of claim 15, wherein the links, switches and hosts are configured as a tree having nodes and endpoints, the hosts being positioned at the endpoints of the tree.
